(19) United States
(12) Patent Application Publication
(10) Pub. No.: US 2009/0094141 A1
(43) Pub. Date: Apr. 9, 2009

(54) Business integration of integrated gasification combined cycle power plant and coal to liquid fuel plant

(75) Inventors: Joseph A. Regnery, Castle Rock, CO (US); Richard O. Sheppard, Evergreen, CO (US)

Correspondence Address: CONLEY ROSE, P.C.;David A. Rose, P. O. BOX 3267, HOUSTON, TX, 77253-3267, US

(73) Assignee: RENTECH, INC., Los Angeles, CA (US)

(21) Appl. No.: 12/210,937

(22) Filed: Sep. 15, 2008

Related U.S. Application Data
(60) Provisional application No. 60/972,631, filed on Sep. 14, 2007.

(51) Int. Cl. G06Q 10/00; G06Q 50/00; G06Q 40/00; G06Q 90/00

(52) U.S. Cl. 705/28; 705/412; 705/35

(57) ABSTRACT

Methods of operating a business arrangement for an integrated CTL process and IGCC facility are disclosed herein. An embodiment of the method encompasses operating the integrated CTL and IGCC facility to optimize profitability, revenue and monitor inventory. Some advantages of the disclosed methods include reduced capital expenditures and increased availability of power or syngas during emergencies. Further advantages of the disclosed methods will be described in more detail herein.

### CROSS-REFERENCE TO RELATED APPLICATIONS

This application claims the benefit under 35 U.S.C. § 119(e) of U.S. Provisional Patent Application No. 60/972,631, filed Sep. 14, 2007, the disclosure of which is incorporated herein by reference in their entirety for all purposes.

### BACKGROUND

1. Field of the Invention

This invention relates generally to the field of clean-coal energy production. More specifically, the invention relates to a method of conducting business transactions between two sections of an integrated coal-to-liquid (CTL) fuel, and electrical-power production facility.

2. Background of the Invention

Rising worldwide oil demand has increased the cost of oil distillates significantly enough to incentivize investment in alternative sources for meeting the energy demands. Natural gas, coal, and biomass are abundant energy sources with applications as fuel to replace oil distillates in certain power generation applications. The United States, in particular, contains large known reserves of coal, but while abundant, the location of these deposits far from industrialized infrastructure represents a significant transportation hurdle to the development of these technologies.

Existing coal-combustion electric-energy facilities are facing stricter emissions regulations. Current regulations already limit the amount of sulfur, oxides of nitrogen, and greenhouse gas emissions from these facilities. The tightening regulations are making coals high in these materials unusable for electricity generation. Furthermore, failure to comply with these regulations results in hefty penalties in the form of fines, shutdowns, and limited operations. Renovations to comply with the regulations are requiring substantial investment in scrubbing and trapping technologies with minimal improvements in efficiency of operation. In particular, alternative methods to exploit the energy in coal are necessary to unlock the potential of the reserves available in the United States.

One such method is the Integrated Gasification Combined Cycle (IGCC) power plant. Electricity is produced from the combustion of a synthesis gas (syngas) produced by the gasification of coal. The process of gasification, itself, requires reacting coal with limited oxygen at high temperatures for the production of a gas mixture, or syngas. The syngas is, in turn, combusted for electrical power production. In an IGCC plant, the excess heat from the gasification process can be used for generating further electricity by conventional steam turbines. The process of gasification removes the pollutants such as mercury, arsenic, nitrogen oxides, sulfur oxides, so that the syngas may be combusted with a low carbon dioxide emission. The emissions from an IGCC power plant compare favorably with coal fired electrical power plants.

Coal may also be converted to a synthetic liquid fuel starting with the syngas. Liquid fuels have a significant advantage over coal, because they are easily transported long distances without expensive processes or packaging. Further, liquid hydrocarbons are capable of distillation into products such as diesel, and gasoline. Specifically, Fischer-Tropsch (FT) reactor facilities process the catalyzed chemical reaction in which carbon monoxide and hydrogen from the syngas are converted into liquid hydrocarbons. The liquid products combustion emissions are significantly lower in the monitored pollutants.

The IGCC and FT process represent two coal uses, to reduce dependence on oil distillates and both processes require a gasification step for operation. As discussed in the industry the logical step would be to combine the facilities around the gasification unit to produce one facility for both productions. This method does not take into account the difficulties of merging separate infrastructures, and usably share a single syngas production unit as a joint business venture.

U.S. patent application Ser. No. 12/210,728 filed Sep. 15, 2008 incorporated herein by reference in its entirety, for all purposes, discloses a possible novel arrangement of an integrated facility including an IGCC section and Fischer-Tropsch coal to liquid section. The integrated facility incorporates multiple paths for the production and transfer of material between the sections. However, the raw material and financial transactions between the sections of a multi-path integrated facility may be complex and dependent on the markets for each product, requires certain business methods for effective operation.

Accordingly, there is a need for a business method for a novel integration IGCC and FT facilities in the industry.

### BRIEF SUMMARY

Methods of operating a novel integrated CTL process and IGCC facility are disclosed herein. Embodiments of the methods encompass various aspects of operating the integrated CTL and IGCC facility to optimize profitability and revenue. Some advantages of the disclosed methods include reduced capital expenditures and increased availability of power or syngas during emergencies. Further advantages of the disclosed methods will be described in more detail below.

In an embodiment, a method of operating a coal-to-liquid (CTL) process and an Integrated Gasification Combined Cycle (IGCC) facility comprises integrating a CTL process and an IGCC facility by sharing an air separations unit, a coal preparation unit, and a coal-handling unit to form an integrated CTL process and IGCC facility. The CTL process and the IGCC facility each comprise a respective gasification unit for the production of syngas. The method further comprises splitting ownership of the integrated CTL process and IGCC facility between two or more owners. In addition, the method comprises optionally, selling a call option for the syngas produced from the IGCC facility process to the IGCC facility. The method further comprises optionally, selling syngas produced from the IGCC facility to the CTL process with callback rights. The method also comprises optionally, selling excess products, byproducts, and excess electricity produced from the CTL process to the IGCC facility.

In another embodiment, a method of operating a coal-to-liquid (CTL) process and an Integrated Gasification Combined Cycle (IGCC) facility comprises integrating a CTL process and an IGCC facility by sharing an air separations unit, a coal preparation unit, and a coal-handling unit to form an integrated CTL process and IGCC facility. The CTL process and the IGCC facility each comprise a respective gasification unit for the production of syngas. The method additionally comprises selling ownership of shared coal preparation and handling units to a third party owner. Moreover, the method comprises dividing ownership of the integrated CTL process and IGCC facility. The method also comprises negotiating delivery of raw materials to each section independently with third party ownership. Furthermore, the method comprises evaluating need for electrical power, and liquid fuels, or products. The method also comprises negotiating distribution of syngas to each section from the processing units of both sections.

Thus, embodiments described herein comprise a combination of features and advantages intended to address various shortcomings associated with certain prior methods. The various characteristics described above, as well as other features, will be readily apparent to those skilled in the art upon reading the following detailed description of the preferred embodiments, and by referring to the accompanying drawings.

### BRIEF DESCRIPTION OF THE DRAWINGS

For a detailed description of the preferred embodiments of the invention, reference will now be made to the accompanying drawings in which:

FIG. 1 illustrates an embodiment of a Novel Integrated Coal to Liquid and Integrated Gasification Combined Cycle clean coal facility.

### NOTATION AND NOMENCLATURE

Certain terms are used throughout the following descriptions and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”

Additionally, in the following discussion and in the claims the term “IGCC” is used to refer to an Integrated Gasification Combined Cycle electricity generation plant or facility. Similarly, “CTL’ is used to refer to a Fischer-Tropsch reactor based plant for the synthesis of liquid hydrocarbons from coal, or coal products without limitation by the individual processes involved. Additionally, the term syngas refers to a gaseous mixture comprised of varying amounts of the main components carbon monoxide and hydrogen with potentially other gaseous molecules.

In further discussion the term “facility,” “section,” and “unit” are used in open-ended fashion and thus should be interpreted to mean a premises for a system of components for the execution of a step, or series of steps and associated devices within the described process.

### DETAILED DESCRIPTION OF THE PREFERRED EMBODIMENTS

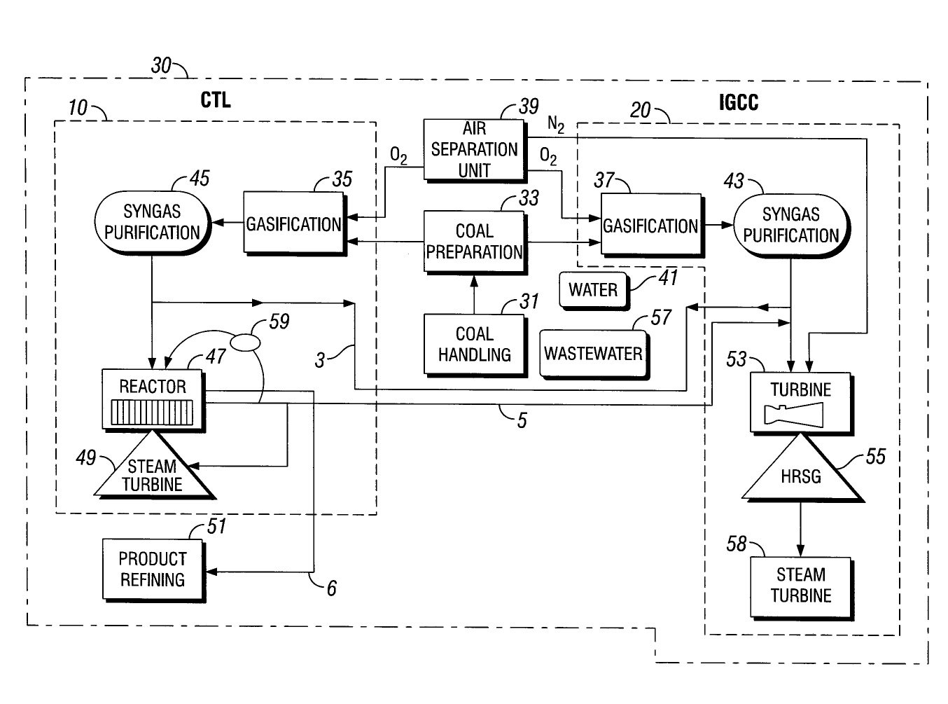

FIG. 1 illustrates an embodiment of an integrated Coal to Liquid Fuel and Integrated Gasification Combined Cycle power plant facility, as disclosed in U.S. patent application Ser. No. 12/210,728, filed Sep. 15, 2008 incorporated herein by reference in its entirety for all purposes. The integrated facility comprises an IGCC electrical plant section and a CTL Fischer Tropsch liquid hydrocarbon production section with a plurality of coal-derived syngas sharing paths. The plurality of paths to share syngas between the adjacent sections of an integrated facility allows production to respond to market demands. Each section retains its own plurality of gasifiers and syngas purification units. In an embodiment the coal handling, coal preparation, water, wastewater and air separation units are shared between sections. Alternatively, the gasifier and syngas purifiers are shared between the sections. In further embodiments gases, electricity, water, and steam can be routed from either section of the integrated facility to the adjacent section. The infrastructure required for sharing, transporting, or storing these materials is considered a shared unit of the integrated facility.

A facility integrated in this manner maintains a novel business arrangement. In embodiments, each section of an integrated facility may be separately owned with joint ownership of the shared infrastructure. In alternative embodiments, percentages or shares of the facility and sections may be owned by different people, organizations, or corporations as understood by one skilled in the art. The ownership of the facility may be considered equity in the facility. The equity or other shares in ownership may be sold or exchanged for a cost based on the profitability of the integrated facility.

In alternative embodiments third party ownership of shared facility units eliminate the capital expenditure for the shared units from the businesses of each section. In this embodiment, service and supply contracts are independently reached between each sections' ownership and the third party ownership of the shared units. A facility integrated in this manner maintains a novel business arrangement such that the sections of the facility interact with each other and the owners of the shared units as a means to respond to the potential markets for the products of each section.

In further embodiments, the shared facilities provide increased availability to required reactant material such as but not limited to emergency, maintenance or high demand situations. The construction of multiple and spare gasifiers in each section to meet this demand is applicable to the business as the capability to produce syngas relates proportionately to the operational capabilities of the integrated facility. The plurality of these units can be designated as primary and secondary units, to differentiate between the units providing the facility required syngas, and the units providing supplementary quantities of syngas. The presence of a plurality of syngas production units allows each section to purchase syngas from the adjacent section's supply. Additionally, the requirement for cycling, and off-peak maintenance is reduced. The increased operations increase the capacity for the facility to sell products as the time each section is off line is decreased.

In an embodiment, the cost of syngas is at a negotiated price agreed upon between the sections for specific situations. Commercial transactions between the sections of the integrated facility determine the source of syngas for production of liquid fuel or electricity. The commercial transactions comprise sales of financial product, such as but not limited to, an option, a call, an annuity, or other financial product as known to one skilled in the art. Alternatively, the cost of syngas may be obtained electronically from a commodity market, for instance on the New York Mercantile Exchange. The cost of syngas may be set in relation to an indicator from a commodity market, for instance oil prices. In certain embodiments, the indicator cost, the syngas cost, and the conditions for the sale may be recorded.

In one embodiment, the IGCC section sells the syngas produced in its gasifier units to the CTL section at a negotiated rate. The rights for the CTL to utilize this source maybe be retracted, or called back by the IGCC section in a given situation. The IGCC section retention of call back rights is maintained for reasons such as, but not limited to, a sharp increase in demand or peak, or additionally in the event of IGCC gasifier unit failure, repair, and maintenance. Alternative situations necessitating syngas call back may be any known to one skilled in the art. The cost of syngas between the sections of the unit further comprises inventory management.

During peak seasons, the IGCC section sells a call option for syngas produced by gasification units to the CTL section. In an embodiment, the IGCC section sets and maintains a call-option price signal such as, but not limited to the cost of replacement power, or the cost replacement fuel. The price signal is the period in which the cost of the replacement power or replacement fuel is lower than the cost of syngas. In embodiments, the call-option price signal may be any of those known to one in the art. When the call-option price signal is reached, the IGCC section sells syngas to the CTL section at a negotiated price, and purchases the alternative fuel for electrical power production.

In further embodiments, during off-peak seasons, the IGCC section sells syngas from primary gasification units to CTL section at a negotiated price. The syngas production units of either section may sell syngas to the adjacent section at a negotiated price, or time without limitation as known by one skilled in the art. The integrated facility maintains production of syngas in both sections in order to respond to intermediate or peak power production. In this mode of operation the IGCC can have the capacity for load following or spinning reserves to meet grid demands. Furthermore, in embodiments, the IGCC unit retains capacity to increase production by purchasing back syngas from the CTL unit, or purchasing an alternative power supply.

In an embodiment, the excess gaseous products from the CTL production of liquid fuels maybe sold to the IGCC section. The gaseous products or tail gases can be recycled through the CTL facility to produce liquid fuels. In times when the CTL unit is in capable of utilizing the recycled tail gas selling it as a fuel for IGCC electricity production is mutually advantageous business method for the adjacent sections. Excess products in the CTL section are sold to the IGCC, which obtains a nearby fuel source for electricity production. The proximity of the CTL unit may reduce the cost of transportation of the fuel, while the IGCC may continue to sell the electricity at a given rate.

In further embodiments, the CTL section sells electricity to the IGCC section at a negotiated rate. The chemical reaction produces steam from water used to cool the reactors. The steam may be used to power a steam turbine to produce electricity. Additionally, the CTL section may purchase electricity from the grid, or from the IGCC section. In the case of an excess of purchased electricity, the surplus may be sold to the IGCC section. In further embodiments, electricity purchased from the IGCC section may be returned for a refund, credit, or waiver without limitation. In embodiments, the transactions regarding electricity represent a further method of business accounting and inventory management within the integrated facility.

While embodiments, of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims that follow, that scope including all equivalents of the subject matter of the claims.

What is claimed is:

1. A method of operating an integrated coal-to-liquid (CTL) process and an Integrated Gasification Combined Cycle (IGCC) facility comprising:
a) integrating a CTL process and an IGCC facility by sharing an air separations unit, a coal preparation unit, and a coal handling unit to form an integrated CTL process and IGCC facility, wherein the CTL process and the IGCC facility each comprises a respective gasification unit for the production of syngas;
b) splitting ownership of the integrated CTL process and IGCC facility between two or more owners;
c) selling a call option for the syngas produced from the IGCC facility process to the IGCC facility;
d) selling syngas produced from the IGCC facility to the CTL process with callback rights;
e) selling excess products, byproducts, and excess electricity produced from the CTL process to the IGCC facility; and
f) recording the cost of the transaction and the amount of inventory.

2. The method of claim 1 wherein c) further comprises a call-option price signal comprising replacement power.

3. The method of claim 1 wherein c) further comprises a call-option price signal comprising the cost replacement fuel for the CTL process.

4. The method of claim 1 wherein d) further comprises exercising callback rights during peak season.

5. The method of claim 1 wherein d) further comprises exercising the callback rights during failure of the IGCC gasification unit.

6. The method of claim 1 wherein e) further comprises distributing raw material to the CTL process and the IGCC facility from the shared units.

7. The method of claim 7 further comprising changing the distribution of raw material to each section from the shared units based on a price signal.

8. The method of claim 8 wherein the price signal further comprises the profitability of the integrated facility.

9. The method of claim 1 wherein e) further comprises negotiating the distribution of raw materials between the CTL section and the IGCC section.

10. The method of claim 1 wherein b) further comprises joint ownership of shared units of the integrated facility.

11. The method of claim 1 wherein d) further comprises a price trigger consisting of the cost of an alternative for electricity production.

12. The method of claim 11 wherein the alternative comprises the obtaining liquid natural gas.

13. The method of claim 1 wherein e) further comprises negotiating the price of the excess products, byproducts, and excess electricity produced from the CTL process.

14. The method of claim 1 wherein f) comprises electronically accessing the record at a future date.

15. A method of operating an integrated coal-to-liquid (CTL) process and an Integrated Gasification Combined Cycle (IGCC) facility comprising:
a) integrating a CTL process and an IGCC facility by sharing an air separations unit, a coal preparation unit, and a coal handling unit to form an integrated CTL process and IGCC facility, wherein the CTL process and the IGCC facility each comprises a respective gasification unit for the production of syngas;
b) selling ownership of shared coal preparation and handling units to a third party owner;
c) dividing ownership of the integrated CTL process and IGCC facility;
d) negotiating delivery of raw materials to each section independently with third party ownership
e) evaluating need for electrical power, and liquid fuels, or end products; and
f) negotiating distribution of syngas to each section, from the processing units of both sections.

16. The method of claim 15 wherein f) further comprises selling options for the distribution of syngas produced by the IGCC units to the CTL section.

17. The method of claim 15 wherein f) further comprises selling a gaseous byproduct of the CTL section to the IGCC section.

18. The method of claim 15 wherein d) comprises selling surplus electrical credits purchased by the CTL section to the IGCC section.

19. The method of claim 15 wherein b) comprises the third party ownership paying for the construction of the shared units of the integrated CTL process and IGCC facility.
